(19) United States
(12) Patent Application Publication
(10) Pub. No.: US 2010/0036674 A1
(43) Pub. Date: Feb. 11, 2010

(54) METHOD FOR SHIPPING DELIVERIES; SHIPPING STATION AND LOGISTICS SYSTEM

(76) Inventor: Brian Johnson, Surprise (DE)

Correspondence Address: International IP Law Group, P.O. BOX 691927, HOUSTON, TX, 77269-1927, US

(21) Appl. No.: 12/532,376

(22) PCT Filed: Mar. 19, 2008
(86) PCT No.: PCT/EP08/02198

§ 371 Date: Sep. 21, 2009

Related U.S. Application Data
(60) Provisional application No. 60/919,680, filed on Mar. 22, 2007.

(51) Int. Cl. G06Q 10/00

(52) U.S. Cl. 705/1

(57) ABSTRACT

There is provided a system and method for operating an electronic parcel compartment system, whereby at least one user is authorized to deposit a shipment so that the shipment can be forwarded to a logistics service provider. An exemplary method comprises acquiring data about an intended shipment and user data by a first acquisition device separated from the electronic parcel compartment system. The exemplary method also comprises supplementing the shipment information pertaining to the shipment via a second acquisition device located at the electronic parcel compartment system. The exemplary method additionally comprises verifying access rights of the user with a verification device that is arranged within the electronic parcel compartment system, by associating the acquired user data with a stored user profile and verifying validity of the acquired shipment.

### CROSS REFERENCE TO RELATED APPLICATIONS

Pursuant to 35 U.S.C. §371, this application is the United States National Stage Application of International Patent Application No. PCT/EP2008/002198, filed on Mar. 18, 2008, the contents of which are incorporated by reference as if set forth in their entirety herein, which is entitled to the benefit of U.S. Provisional Patent Application No. 60/919,680, filed Mar. 22, 2007, the contents of which are incorporated by reference as if set forth in their entirety herein.

### BACKGROUND

A method for depositing goods that an addressee wishes to return to a deliverer is known from German patent DE 100 00 830 C2. The method provides for identifying the addressee at the shipping station, after which he can deposit the shipment in a compartment of the system. The addressee also enters the address data of a deliverer who is authorized to have access. The deliverer subsequently identifies himself at the system and removes the shipment.

### SUMMARY OF THE INVENTION

An exemplary embodiment of the present invention relates to a method for operating a logistics system, whereby at least one user is authorized to deposit shipments into the logistics system. The exemplary method comprises accepting a shipment from a user so that it can be forwarded to a destination.

In addition, exemplary embodiments of the present invention may provide a method for depositing shipments, whereby usability for users should be increased. Furthermore, safeguards against fraudulent use during the handling of shipments should be improved.

Exemplary embodiments of the present invention include a method for operating a shipping station, whereby at least one user is also raised to deposit shipments, whereby the method comprises depositing of a shipment from a user so that it can be forwarded to a logistics service provider.

According to an exemplary embodiment of the present invention, this method may include the following steps:
acquiring data about an intended shipment by a first acquisition device separated from the shipping station and
supplementing the shipment information pertaining to the shipment via a second acquisition device located at the shipping station.

In an exemplary embodiment of the invention the first acquisition device is connected to the internet.

It may be advantageous, if the second acquisition device is a terminal located at the shipping station.

In an exemplary embodiment of the invention, information acquired at the first acquisition device is stored in a key tag.

In an exemplary embodiment of the present invention, the acquiring of data about the intended ship by the first acquisition device includes information about intended deliveries.

In an exemplary embodiment of the present invention, the information about the intended shipment contains an indication of items intended for shipment.

It is advantageous if the key tag is scanned at the shipping station.

In an exemplary embodiment of the present invention, the shipping station includes a display.

In an exemplary embodiment of the present invention, the display displays information about pre-entered items.

In an exemplary embodiment of the present invention, user data of a user is acquired at a first acquisition device separated from the shipping station.

A method according to an exemplary embodiment of the present invention may comprise verifying the access right of the user in a verification device by associating the acquired user data with a stored user profile.

Exemplary embodiments of the present invention may include a shipping station that comprises a scanner which is capable of reading information entered at a first acquisition device and stored in a key tag from the key tag and that it furthermore comprises second acquisition device for acquiring supplementing shipment information.

Furthermore, an exemplary embodiment of the present invention encompasses a logistics system that is adapted to carry out a transport of shipments.

This logistics system may comprise a central control computer capable of communicating with a first acquisition device and that furthermore comprises a shipping station. The shipping station is located separated from the first acquisition device. Furthermore, the shipping station may be capable of accepting a disposal of shipments and to supplement the shipment information via a second acquisition device.

### BRIEF DESCRIPTION OF THE DRAWINGS

FIG. 1 is a perspective view of a terminal for usage at the shipping station (10), according to an exemplary embodiment of the present invention; and

FIG. 2 is a block diagram of logistics systems with a shipping station (10), according to an exemplary embodiment of the present invention.

### DETAILED DESCRIPTION OF SPECIFIC EMBODIMENTS

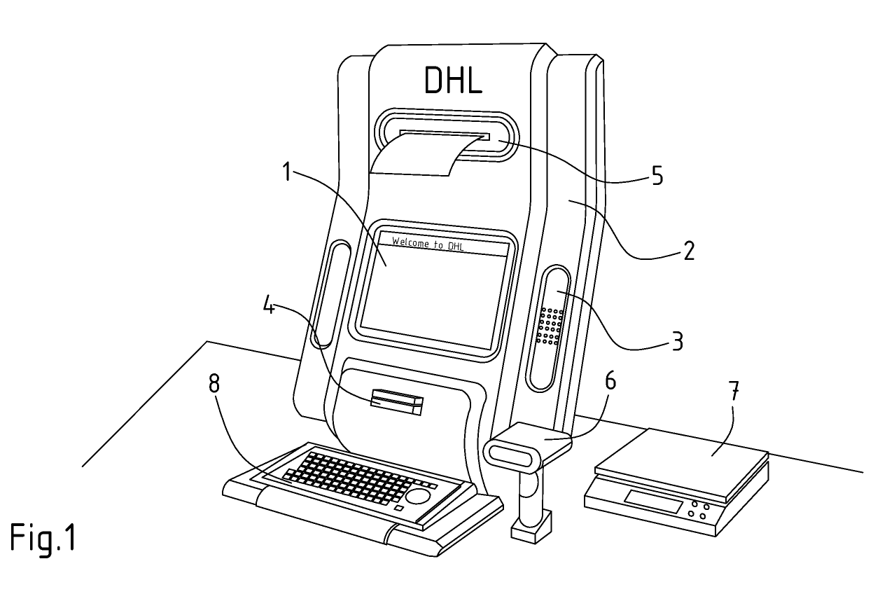

FIG. 1 shows a shipping station with a terminal 2. This terminal contains a display 1. The display 1 is e.g. a flat screen, e.g. an LCD monitor. It is possible to use a standard monitor, e.g. a standard 17 inch LCD monitor with a touch screen.

The terminal 2 is made of an appropriate material, e.g. a material which is capable of protecting the interior of the station from external influences. It is therefore especially useful that it consists of a durable material, e.g. a plastic material, e.g. polycarbonate.

In order to facilitate a communication with a service station of a logistics system provider, the shipping station contains a speaker phone 3.

For carrying out payment procedures it is advantageous, that the shipping station contains a credit card reader 4.

Labels, waybills, or other items to be printed are printed by a printer 5. Advantageously the printer 5 is implemented in the terminal. The printer is e.g. a Thermal Label Printer.

In order to facilitate a communication with a service station of a logistics system provider, the shipping station contains a speaker phone 3.

In one exemplary embodiment of the invention, a scanner 6 located at the shipping station. The scanner 6 is e.g. a one-dimensional (bar code), two-dimensional (matrix-code) scanner or a RFID reader. The scanner is enabled to read coded information, e.g. information about items to be shipped.

A scale 7 allows a weighing of items to be shipped. The scale and the terminal 2 are connected via an appropriate data link. This data link can be carried out by wire or as a wireless solution. An exemplary embodiment of a wireless solution is Bluetooth.

To facilitate a choice of options, the shipping station contains a keyboard 8.

With an aesthetically pleasing design and small footprint, IntelliShip offers a powerful shipping platform that can be deployed anywhere around the globe. This innovative and unique “All-In-One” design is ideal for the small and medium business user. With the ability to handle both low and high volume shippers, IntelliShip is more than just another shipping system. For users that want a powerful system and who have limited work space, IntelliShip is an intricate and vital tool to solve their shipping needs.

The shipping station according to an exemplary embodiment of the present invention can handle a plurality of suitable key tags. Examples of these key tags are barcodes, matrix codes or RFID-tags.

Reading functionality for the key tags is included in the IntelliShip system. With new mandates on RFID technology being introduced more frequently the unique profile selection mechanism makes it simple for a user to comply with any and all mandates as they are introduced and modified by different industries.

### Automated User Care Interface

Exemplary embodiments of the present invention include a higher level of user service. This includes to actually “listen” to the needs, suggestions and complaints of users. IntelliShip offers a direct line of communication from the user to various departments of the logistics system provider. This communication is made possible via an on-screen survey that can be customized to solicit user feedback on a daily, weekly, bi-weekly or monthly basis.

Daily Issues (Suggestions/Recommendations) Survey

Weekly/Monthly Performance Survey (Courier/Help Desk/Software)

### Proactive Alert Link (PAL)

This innovative feature proactively alerts users to any system outages, service issues or any other situations that may adversely affect their shipping activities. On-screen and audio alerts will give users adequate time to make alternative shipment arrangements in the event DHL is experiencing service problems.

Hub malfunctions

Snow delays

Airport Closures etc.

### A.S.S.I.S.T. (Automated Shipment Summary & Inventory Status Transmission)

The IntelliShip A.S.S.I.S.T. functionality provides a convenient way for users to inform DHL that a regularly scheduled pick-up is not required. This unique feature will also save couriers time and make them more efficient. At pre-determined intervals (i.e. 2 hours, 1 hour, 30 minutes) prior to the courier's scheduled pick-up time, an on screen alert (with audible) will be displayed. It will inform the user that he has made no shipments for the day. It will then give him options to cancel the pick-up that is scheduled for the day. If the pick-up is cancelled, the courier/station can be notified via email, SMS messaging etc.

Additionally, as supplies are used by the user, IntelliShip will auto-order needed supplies before the supplies are depleted by the user.

### Video Security & Training Camera

A small built in video camera assists with shipper ID, package security and can be utilized for live, interactive video training.

### Interactive Video Trainer

With the escalating costs associated with training users, IntelliShip makes training easy and convenient for new and current users. Professionally produced video training modules can be displayed onscreen as needed. Combined with interactive user participation as they are walked through the training modules, this is a win-win training solution for the logistics systems providers and the users.

According to an exemplary embodiment, the shipping station (10) furthermore includes an enhanced disaster recovery support.

Performed properties of the enhanced disaster recovery support are:

Software rollback to last time system was functioning properly. (1 hour ago etc.)

Complete system re-imaging to original installed configuration.

Remote access technical support

Hardware health reporting functionality

Automated database archiving

Auto re-imaging for “On-The-Fly” new installations

### Enhanced Update Features & Functionality

ESD “Changes Only” update

“Rapid Rate” updates

“Micro-Burst” software updates

### Live User News Updates

Scrolling news bar with important user information
∘ Marketing communications
∘ Side bar advertising opportunity
∘Shipping updates etc.

### User Tracking Dashboard

Real-time tracking on all shipments

Auto-print/email successful shipping notification

Auto-track inbound shipments

Advanced notification of a possible shipping guarantee that was missed

Visual map display for tracked items (Google Earth Interface)

It is furthermore to integrate an enhanced graphical user interface (GUI).

Properties of this graphical user interface may include:

Interactive touch-screen shipping

Auto advancing screens

Auto document completion (SED & CI) and required information prompting

Advanced voice recognition interface
▪ Package tracking
▪ Package shipping
▪ History Search etc.

### Enhanced User Support Features

Touch-screen help desk access icon
▪ Auto-dialer calls help desk and the built-in speakers and microphone allow immediate help desk support.

Biometric security access allows for employee activity tracking and system security

Touch-screen icons programmed for users internal departmental contacts

### Backend Master Database

Compiled for direct marketing efforts

### Enhanced Reporting Features

Intuitive and user friendly “drag and drop” report creation utility for users to use.

Additional Features are e.g.:

Loyal shipper auto-configuration and tracking feature

Real-time waybill pulling w/immediate billing

Retail option

Credit card ready

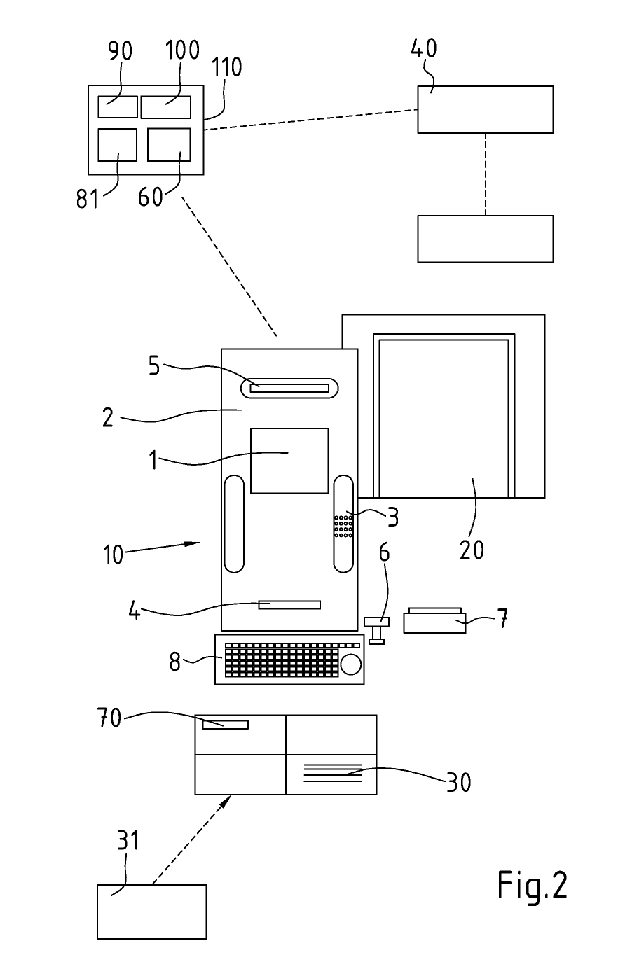

FIG. 2 shows a schematic depiction of an electronic shipping station 10 with its associated components and users. The shipping station can especially be used by several users 31 and by one or more logistics service providers 40.

First acquisition devices 50 are placed outside the shipping station. They are e.g. a computer terminal which can be connected to the internet.

Second acquisition devices 80 are integrated in the shipping station.

The shipping station can be integrated in a logistics system.

The logistics system is a logistics system in its broadest sense. The logistics system especially includes systems, which contain devices and/or arrangements for carrying out the transport and/or handling of items. These items are shipped from the shipping station to a destination. They are therefore also called shipments.

This especially encompasses a transport of items—especially of postal deliveries—from a starting point to a destination along a transport route.

The logistics system could comprise several types of shipping stations.

Examples of the shipping station are: an electronic parcel compartment system, a drop box or a terminal which could be combined with the electronic parcel compartment system, the drop box or post office counter.

The first acquisition device (50) is for example a computer which could be connected to a data network.

The data network is for example the internet.

In the method shown, the user would like to send shipment 30 to a receiver via a logistics service provider. The user/recipient might originally have received the shipment by having picked it up at a shipping station or through a regular shipping at his home address. In this context, such a shipment is referred to as a return shipment 30.

In order for the user 31 to access the operating functions at the shipping station, he normally has to identify himself at an operating device of the system. This can be done by entering a PIN code or some other access code. In an exemplary embodiment, the entry of access data can be augmented or replaced by inserting a user card.

The user data is acquired in a first acquisition device 50 which, depending on the type of data acquisition, can be, for instance, a card reader, a keyboard and/or a touch screen and/or a scanner.

It is possible to place the first acquisition device outside the shipping station. This allows to register user data early and to facilitate a registration of the shipment at the shipping station.

However, it is also possible to integrate the first acquisition device in the shipping station.

If the first acquisition devices are separated from the shipping station, it is nevertheless possible that they are electronically connected with the shipping station, e.g. through the internet.

However, it is also possible that no connection between the first acquisition device and the shipping station exists.

In this case it is preferred, that information acquired at the acquisition device is stored in a key tag.

The key tag allows a facilitated exchange of information at the shipping station and accelerates a procedure of registering the shipments.

It is especially preferable to acquire user data by the first acquisition device.

The acquired user data is associated with a user profile and the associated access rights of the user are verified in a verification device 60 belonging to the shipping station. The verification device 60 can be located within the shipping station or can be connected to the system, for example, online. The online connection can be permanent or it can exist only while procedures are being carried out at the shipping station.

In the exemplary embodiment shown in FIG. 2, the verification device 60 is located in a central management unit 110 that preferably manages information for several shipping stations. The information is advantageously stored and managed in a database 90. In addition to user profiles, the managed information can also include data relating to logistics service providers and status data about the shipping stations.

In an exemplary embodiment, the central managing unit 110 also has a notification component 100 that serves to transmit messages between the shipping station, the central data processing unit, users and/or logistics service providers. The notification component sends users and logistics service providers, for example, automated messages via SMS or e-mail about deposited shipments.

If the verification of a user profile indicates that the user is authorized to have access and is permitted to use functions for the acceptance of returns, then the applicable operating functions are offered to him. This is done, for example, via instructions on the display device such as a monitor. If the verification ascertains that the user is not authorized to have access or is not permitted to use the return function, then the procedure is terminated and preferably a message is displayed to the user. As an alternative, the functions to which the user has access can be displayed without an explanatory message.

According to an exemplary embodiment of the present invention, in order to deposit a return shipment 30, the appertaining shipment information 70 has to be acquired first. This information is present in the form of an imprint, a sticker or a transponder (RFID) on the return shipment. The shipment information can be generated, for example, by a numeric string or a barcode. The acquisition is carried out via a second acquisition device 80 which can be, for instance, a scanner. If the shipment information is formed by a numeric string, this numeric string can also be entered by the user using an input device such as a keyboard or a touch screen.

The validity of the acquired shipment information is verified by a comparison with the stored information. The data and also the appertaining verification device 60 can be arranged within the shipping station or in the central data processing unit. The verification can be carried out, for example, on the basis of the number of digits and/or on the basis of a checksum logic. If the verification shows that the shipment information is invalid, the procedure is terminated and a message to this effect is displayed to the user. Invalid shipment information is present, for example, if incorrect data formats were acquired, which is an indication of an attempted fraudulent use of the return function. Moreover, if a logistics service provider withdraws from the shipping station, this could be a case of obsolete shipment information that no longer allows returns of the original shipment.

If the verification indicates that the acquired shipment information is valid and can be associated with a logistics service provider, then a compartment 20 is released for depositing the return shipment and it is closed after the shipment has been deposited there. A compartment can be selected, for example, as a function of the size of the shipment. If the payment of an additional sum is required in order to deposit the returns, then payment verification can be carried out before a compartment is opened. This is possible, for example, by reading in payment information such as stamps or value coupons on the shipment. Payment functions such as coin slots, reading devices for cash cards, credit cards, Euro-check cards or reading devices via cell phones can be provided in order to transact the required payments.

The acquired shipment information is stored in a storage device 81. The storage device can likewise be located within the shipping station or in the area of the central managing unit 110. If the storage device is in the central data processing unit, as shown in FIG. 1, the shipment information is associated with the shipping station in question. Moreover, the information is associated with a logistics service provider. This is necessary for notifying the logistics service provider and/or for displaying a return when a deliverer of the logistics service provider logs in.

In an exemplary embodiment of the invention, a message is transmitted by the notification component 100 to a logistics service provider 40 indicating that a user has deposited a return shipment for him to pick up. In addition to information about the shipment and about the user, this message can also contain information about the time of the deposit and/or about the size of the shipment. Preferably, several messages about deposited returns are bundled in a collective message. This can be done, for example, at fixed intervals such as days or weeks.

In another exemplary embodiment of the invention, the logistics service provider 40 does not receive a message about deposited returns but rather, when a deliverer logs in at the shipping station, a display tells him whether there are any return shipments for him in compartments of the system. These two exemplary embodiments can also be combined so that, in addition to a previously sent message, a display is also shown to the logistics service provider at the shipping station.

In order to remove a return shipment from a compartment, a deliverer normally has to identify himself at the shipping station. During or after the removal of a return shipment, the shipment information present on the shipment is preferably acquired once again and compared to the information stored in the storage device 81. If the shipment code format is not valid or if the acquired shipment information does not match shipment information stored for the shipping station in question, this means that, at the time when the shipment was deposited, a user caused shipment information to be acquired that was not on the shipment in question. In order to prevent such fraudulent use, the procedure is terminated and an operating function is displayed to the deliverer that allows him to readdress the shipment to the user. Preferably, he is offered the possibility to select the reason for readdressing the shipment or to enter this himself.

In case of a negative comparison of the shipment information, the deliverer places the shipment back into the compartment and the user 31 is preferably notified by the notification component 100 that he should remove the shipment. The user can also receive a direct notification (e.g. via e-mail or SMS) from the logistics service provider. It has proven to be advantageous to provide functions via which a user may not deposit any more shipments into the shipping station or remove any shipments from it as long as he has not removed a shipment that has been readdressed to him. Moreover, readdressing the shipment can have the consequence that the user profile in the central managing unit 110 is changed to indicate that the right of this user to deposit return shipments has been withdrawn.

Exemplary embodiments of the present invention include different ways for allowing a user access to functions of the shipping station.

In one exemplary embodiment, access rights of the user are verified in a verification device belonging to the shipping station, by associating the acquired user data with a stored user profile.

In an exemplary embodiment, the acquired user data are stored in a key tag.

The procedure at the shipping station is terminated if the verification device yields a negative result of the verification. If the verification device yields a positive result of the verification, then access is granted to operating functions at the shipping station. Here, a distinction can be made between general operating functions of the shipping station and special operating functions for handling shipments. For example, all of the functions except depositing the item as shipment and/or creating labels for can be displayed and made available to the user if the verification of the user data has shown that the user in question does not have return rights.

The method also provides for a second acquisition device to acquire shipment information pertaining to a shipment. The shipment information is preferably present in the form of a label or key tag. The validity of the acquired shipment information is verified in a verification device belonging to the shipping station by comparing the acquired shipment information to stored data. Moreover, the shipment information is associated with a logistics service provider.

If the comparison of the acquired shipment information with stored data yields a negative result, the procedure is terminated, whereas if the comparison of the acquired shipment information with stored data yields a positive result, a shipping function is enabled—to allow a shipment of the item—so that the shipment can be deposited and the acquired shipment information is stored in a storage device. After a shipment has been deposited, the compartment is closed and a notification indicating that a return shipment has been deposited is transmitted via a notification component belonging to the shipping station to the logistics service provider with which the acquired shipment information was associated.

A deposited shipment may be displayed at the shipping station when the logistics service provider logs in. During or after the removal of a return shipment from a compartment of the shipping station by a deliverer, the shipment information is once again acquired by the second acquisition device and compared by a verification device to the shipment information stored in the storage device, after which the procedure is continued if the data matches, whereas it is terminated if the data does not match, and the deliverer is offered an operating function via which the return shipment can be readdressed to the user. This operating function preferably comprises entering the reasons for readdressing the return shipment to the user. In an exemplary embodiment of the invention, the notification component then notifies the user that a return shipment has been readdressed to him.

In an exemplary embodiment of the invention, the shipment information is a multi-digit numerical code. The validity of the shipment information can be verified on the basis of the number of digits and/or on the basis of a checksum logic stored in the verification device. A fixed set of numbers may be associated with each logistics service provider so that, on the basis of the acquired shipment information, the appertaining logistics service provider can be associated with a return.

It has proven to be advantageous for the notification component to transmit a notification to the logistics service provider comprising information about several return shipments that have been deposited for him. These notifications can be issued, for example, at fixed intervals such as days or weeks so that the logistics service provider receives a message indicating how many shipments and what type of shipments have to be removed at the time of the next login into a given shipping station.

It is also advantageous for the user data to be read in from a user card in the first acquisition device. The data can also be entered by the user via an acquisition device. The second acquisition device is desirably configured in such a way that it scans in the shipment information.

The method according to an exemplary embodiment of the present invention has several advantages. For one thing, it allows the verification of user profiles before a shipment is deposited, which further safeguards the operator of the shipping station against fraudulent use. If a user is not authorized to deposit return shipments, then this particular operating function is not offered to him.

Secondly, the security of the handling of returns is enhanced in that the shipment information is acquired and evaluated at the time of the deposit by the user as well as at the time of the pick-up by the deliverer of a logistics service provider. Hence, a user may only deposit shipments that are provided with a permissible shipment code of a logistics service provider. The shipment code is once again acquired at the time of the pick-up so as to prevent a user from previously causing an incorrect shipment code to be acquired. Since the data is once again compared, cases of fraudulent use are avoided where, at the time of the deposit, a user causes shipment information to be acquired that is not present on the deposited shipment.

Through the association of shipment information with specific logistics service providers, it becomes possible to allow several deliverers to be involved in the operation of a shipping station without compromising the security of the operator against fraudulent use of the system. It is also possible to integrate several users with different access rights.

Exemplary embodiments of the invention are afterwards called walk-up.

The walk-up exemplary implementations of the invention may include different shipping modes.

### An Exemplary of a Shipping Mode According to the Walk-Up Concept for Unregistered Users is Described Afterwards:

Walk-up shipper (non web registered)
∘ This type of shipper is your average “Joe/Jane” off the street that wants to ship a pre-package shipment. This user has no account number assigned to him but instead the IntelliShip is assigned an account number and a book rate file is used for this shipping user. He can bring his package to the IntelliShip and enter the shipment information to print a package label. The transaction is paid at the kiosk by using his credit card and then printing his label. The package is placed in a drop-box for pick-up or left in the store at the predetermined location.
   (Optional configuration would be to pay by cash. IntelliShip prints a receipt for the user to take to the cashier and pay for the shipment and retrieve their package label from the cashier.)

### For Registered Users a Different Method for Carrying Out the Walk-Up Concept are Suitable:

Registered w/Pay Option entered
∘ If a user will be performing shipping on a regular basis, he has the option of pre-registering to receive a virtual shipping account. A few days prior to the user needing to ship, he can go to the web site and enter all of his shipper information and billing information. (Credit Card or checking account and routing number) He can then proceed to enter all his consignee information if known. In a few days he will receive a key tag to place conveniently on his key ring.
   When the user needs to ship, he can walk up to IntelliShip, scan his key tag and he will be prompted for his pin number. Once entered, a list of his pre-entered consignees appears. He can choose from this list or enter a new one and a label will immediately print and his CC or checking account is debited.

Registered w/o Pay Option entered
∘ If a user will be performing shipping on a regular basis, he has the option of pre-registering to receive a virtual shipping account. A few days prior to the user needing to ship, he can go to the web site and enter all of his shipper information but select pay at location as the billing option. He can then proceed to enter all his consignee information if known. In a few days he will receive a key tag to place conveniently on his key ring.
   When the user needs to ship, he can walk up to IntelliShip, scan his key tag and he will be prompted for his pin number. Once entered, a list of his pre-entered consignees appears. He can choose from this list or enter a new one. IntelliShip prints a receipt for the user to take to the cashier and pay for the shipment and retrieve his package label from the cashier.

### LIST OF REFERENCE NUMERALS

3 speaker phone
4 credit card reader
5 printer
6 scanner
7 scale
10 shipping station
20 compartment
30 return shipment
31 user/original recipient
40 logistics service provider
50 first acquisition device
60 verification device
70 shipment information
80 second acquisition device
81 storage device
90 database
100 notification component
110 central managing unit

1-13. (canceled)

14. A method for operating an electronic parcel compartment system, whereby at least one user is authorized to deposit a shipment so that the shipment can be forwarded to a logistics service provider, the method comprising:
acquiring data about an intended shipment and user data by a first acquisition device separated from the electronic parcel compartment system;
supplementing the shipment information pertaining to the shipment via a second acquisition device located at the electronic parcel compartment system; and
verifying access rights of the user with a verification device that is arranged within the electronic parcel compartment system, by associating the acquired user data with a stored user profile and verifying validity of the acquired shipment.

15. The method recited in claim 14, wherein the first acquisition device is connected to the internet.

16. The method recited in claim 14, wherein the second acquisition device comprises a terminal located at the electronic parcel compartment system.

17. The method recited in claim 14, comprising storing information acquired at the first acquisition device in a key tag.

18. The method recited in claim 14, wherein the acquiring of data about the intended shipment by the first acquisition device includes information about intended deliveries.

19. The method recited in claim 14, wherein the information about the intended shipment contains an indication of items intended for shipment.

20. The method recited in claim 14, comprising scanning a key tag at the electronic parcel compartment system.

21. The method recited in claim 14, wherein the electronic parcel compartment system includes a display.

22. The method recited in claim 14, comprising displaying information about pre-entered items on a display.

23. The method recited in claim 14, wherein a key tag contains information about the user.

24. An electronic parcel compartment system, comprising:
a scanner that is adapted to read information entered at a first acquisition device and stored in a key tag from the key tag;
a second acquisition device that is adapted to acquire supplementing shipment information; and
a verification device arranged within the electronic parcel compartment system.

25. The electronic parcel compartment system recited in claim 24, wherein the first acquisition device is connected to the internet.

26. The electronic parcel compartment system recited in claim 24, wherein the second acquisition device comprises a terminal located at the electronic parcel compartment system.

27. The electronic parcel compartment system recited in claim 24, wherein the information acquired by the first acquisition device includes information about intended deliveries.

28. The electronic parcel compartment system recited in claim 24, wherein the information acquired from the first acquisition device comprises information about an intended shipment that contains an indication of items intended for shipment.

29. The electronic parcel compartment system recited in claim 24, comprising a display.

30. The electronic parcel compartment system recited in claim 29, wherein the electronic parcel compartment system is adapted to display information about pre-entered items on the display.

31. The electronic parcel compartment system recited in claim 24, wherein the key tag contains information about the user.

32. A logistics system that is adapted to carry out a transport of shipments, the logistics system comprising:
a first acquisition device;
a scanner that is adapted to read information entered at the first acquisition device and stored in a key tag from the key tag;
a second acquisition device that is adapted to acquire supplementing shipment information;
a verification device arranged within the electronic parcel compartment system;
a central control computer that is adapted to communicate with the first acquisition device; and
an electronic parcel compartment system, located separately with respect to the first acquisition device.

33. The logistics system recited in claim 32, wherein the first acquisition device is connected to the internet.
